(19) United States
(12) Patent Application Publication
(10) Pub. No.: US 2022/0180372 A1
(43) Pub. Date: Jun. 9, 2022

(54) MOBILE SERVICE REQUEST APPLICATION, SYSTEM AND METHOD

(71) Applicant: Matthew Heath Lane, Land O Lakes, FL (US)

(72) Inventor: Matthew Heath Lane, Land O Lakes, FL (US)

(21) Appl. No.: 17/643,018

(22) Filed: Dec. 7, 2021

Related U.S. Application Data
(60) Provisional application No. 63/199,102, filed on Dec. 7, 2020.

(51) Int. Cl. G06Q 30/00; H04L 67/306; H04L 67/02

(52) U.S. Cl. CPC G06Q 30/016; H04L 67/02; H04L 67/306

(57) ABSTRACT

A software application enabling a network mobile devices to place a request for service directly from a user mobile computing device, whereby the mobile devices of service providers can be assign to the user service request so that real time data/updates may then be provided to the user directly from the software application, including status updates, estimated time of arrival, real time geographic location of the assigned service provider, name and contact information of the assigned service providers, and other data relevant to the user account and service request. This data may also be logged under a user account of the user, where the user and service provides may access and view the user service history.

### CROSS-REFERENCE TO RELATED APPLICATION

This application claims the benefit of priority of U.S. provisional application No. 63/198,776, filed 12 Nov. 2020, and U.S. provisional application number 63/199,102, filed 7 Dec. 2020—the contents of both are herein incorporated by reference.

### BACKGROUND OF THE INVENTION

The present invention relates to mobile computer applications, and more particularly, to a mobile application used to streamline managed service provider and customer processes

When a service request is placed, it has normally been done by phone or email with live dispatch personnel. The ability of companies to communicate and respond to service requests from their customers is thus limited by their turnaround time when handling live phone calls, email, or chat. Furthermore, subsequent a request a delay or miscommunication of expectations between the customer and servicing company may occur and, as a result, changes to (or even a status check request of) the initial request would also be routed through the same bottleneck associated with handling live phone calls, email, or chat. Currently, options do not exist for customers requesting service to place a request for service from the convenience of their mobile device, at anytime from anywhere While technology exists for industries such as hospitality and transportation, there are no options for consumer service requests.

A need exists for a mobile application which enables a user who is a customer of a service provider to request a service from their mobile computing device's user interface, which is also configured to receive live updates about the service request as well as see an assigned technician GPS location when the technician is on the way to the user location to address the request.

The present invention avoids bottlenecks associated with conventional means of communication by enabling the user interface of a computing device to become a one-stop-shop for placing a request for service, tracking the status of said service request, or making modification to the service request. A user may initiate a request for service directly from the mobile application, and request and receive live real-time updates as the service request is dispatched and resolved. The data of the service request and service request may also be also logged under a user account associated with the user, where the user may access and view the user service history, as well as make changes to the service request.

The application, system and method of the present invention provides an unprecedented improvement over existing service call fulfillment systems, thereby remedying problems caused by service provider communication and response limited to and by live phone calls, email, or chat and the attendant delays in updates to and changes by the customer.

### SUMMARY OF THE INVENTION

In one aspect of the present invention, service provider system, including the following: a plurality of service provider computing devices connected as a network of computing devices, wherein each respective service provider computing device is configured to transmit a GPS signal and a service provider identifier thereof; each service provider computing device has a provider communication interface; a user computing device having a user communication interface in receipt of a site location and a service request comprising service request data; and a server coupling the plurality of service provider computing devices and the user computing device so that one of the plurality of service provider computing devices is assigned to the service request based in part on the site location and the service request data, wherein the GPS signal of the assigned service provider computing device is represented on a map on the user communication interface.

In another aspect of the present invention, the above-mentioned service provider system includes wherein the server is configured to represent on the user communication interface an estimated time of arrival of the GPS signal at the site location, wherein the server is configured to represent on the user communication interface the service provider identifier, wherein the service provider identifier includes a name and a contact information, wherein the service provider identifier includes a name and a contact information, wherein the service request data comprises a description of a service, wherein the service request data comprises a deadline, and wherein the server is configured to reassign another of the plurality of service provider computing devices based on the description of a service, the deadline, and the GPS signal of the assigned service provider computing device.

These and other features, aspects and advantages of the present invention will become better understood with reference to the following drawings, description and claims.

### BRIEF DESCRIPTION OF THE DRAWINGS

FIG. 1 is a flow chart of an exemplary embodiment of the present invention.

FIG. 2 is a schematic view of an exemplary embodiment of the present invention.

FIG. 3 is a schematic view of an exemplary embodiment of the present invention.

FIG. 4 is a schematic view of an exemplary embodiment of the present invention.

FIG. 5 is a schematic view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a mobile service request application, system, and method.

The system may include at least one computer with a user interface. The computer may include at least one processing unit coupled to a form of memory. The computer may include, but may not be limited to, a microprocessor, a server, a desktop, laptop, and smart device, such as, a tablet and smart phone. The computer may include a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The ordered combination of various ad hoc and automated tasks in the present disclosure necessarily achieves technological improvements through the specific processes described more in detail below. In addition, the unconventional and unique aspects of these specific automation processes represent a sharp contrast to merely providing a well-known or routine environment for performing a manual or mental task.

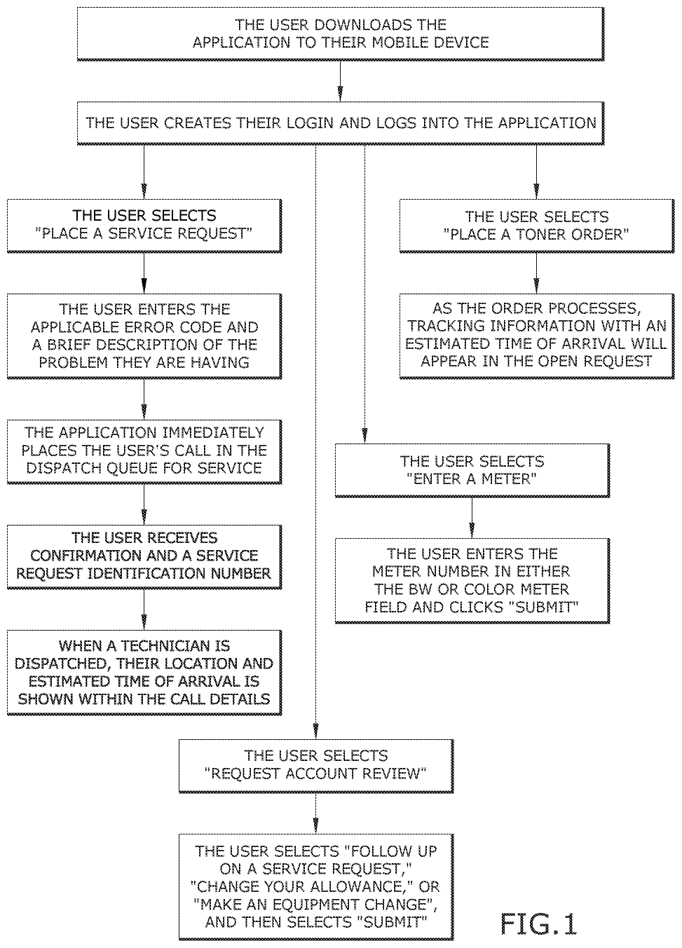

Referring now to the FIGS. 1 through 5, the present invention is directed to a mobile service request application, system, and method. In accordance with an embodiment of the present invention, a mobile application may enable a customer of a service provider to use a mobile computing device to place a service call or request for service. The user may then receive live updates about the service request and view a GPS location of an assigned technician when the technician is on the way to the site location to address to the user's service request. The user may place a request for service directly from the mobile application, and may also receive live, real-time updates as a call is dispatched and resolved. Based on real-time updates, the system or the user may modify the service request or service provider. Service request data may be logged under the user account, where the user may access and view the service history for each service request and associated service request data.

The application, system and method of the present invention solves problems associated with existing service request systems and methods. In prior methods, when a customer service request has been placed, it has been placed by phone or email with live dispatch personnel. A miscommunication of expectations between the customer and the service company may result from these prior methods, and such mistakes would go unnoticed until after the service provider reached the site location. Likewise, changes to an initial service request would be limited by the communication delays of the old model.

The present invention avoids associated problems by enabling the user to place a request for service using the mobile application from the convenience of a mobile computing device at anytime from anywhere.

The mobile application of the present invention allows the user to place a request for service directly from the user mobile phone or mobile device. Once the request has been successfully sent, real time data/updates may then be provided to the user directly from the application, including status updates, estimated time of arrival, real time geographic location of the assigned technician, name and contact information of the assigned technician, and other data relevant to the user account and service request. This data may also be logged under the user account, where the user may access and view the user service history.

Referring now to FIG. 1, in accordance with an exemplary embodiment of the present invention, the application, system, and method may include one or more of the following elements, components, steps, and combinations thereof.

1. A user may download the software application on a computing device 10.

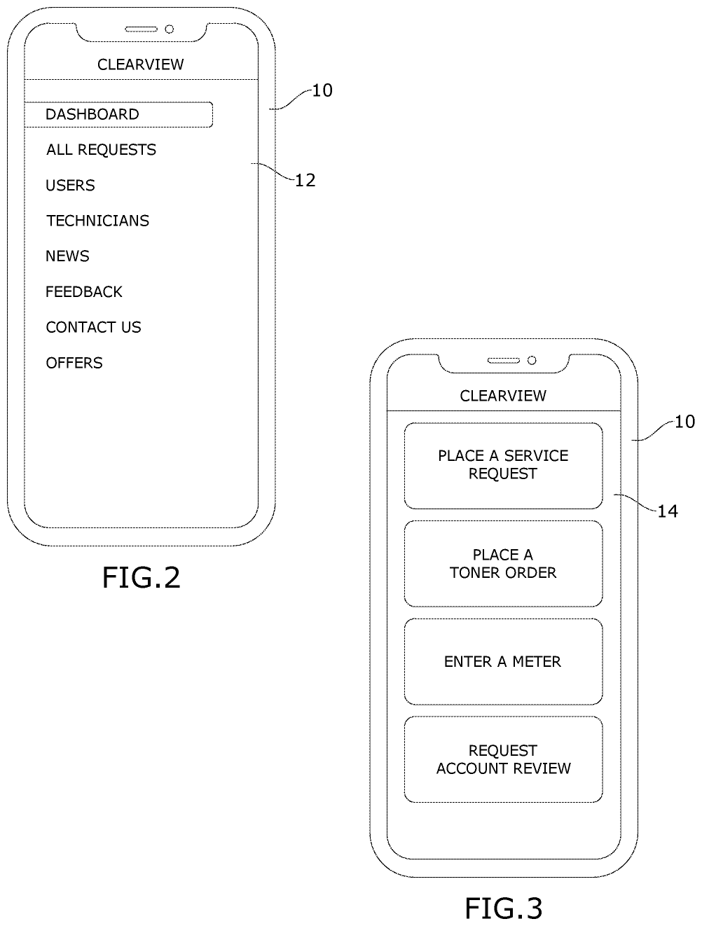

2. By way of a landing page 12 presented via the software application on a user interface of the computing device 10, as illustrated on FIG. 2, the user may create a new user login through inputting user information and logs into the application, wherein the user may define a site location regarding the location where the service is to be provided.

3. The user may select one of a plurality of service requests through a selection page 14 presented by the application via the user interface of the computing device 10, as illustrated in FIG. 3.

4. In certain embodiments, the user may input an applicable error code and/or a brief description of the problem that needs service. Each service request, applicable error code, and/or brief description of the problem/services needed is heretofore referred to as service request data. The service request data may include

5. The application transmits the service request and inputted user data (site location and user information) to the service provider. The user data may include personal information of the user, the service request quote, deadlines, etc. The service request data and associated user data may be retrievably stored in a dispatch database or queue for service. The service provider may use a dashboard to receive and manage the service request.

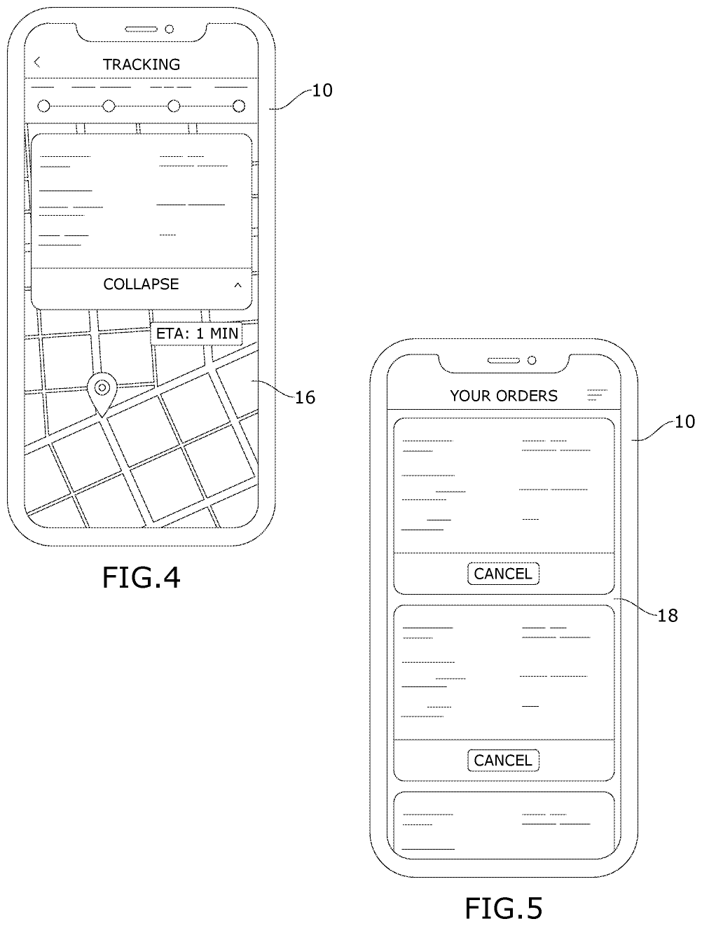

6. The service provider assigns the call to the appropriate technician; the application then notifies the user of receipt of the service request. The user may receive a notification and service request identification number associated with their user data and technician identifying information (TII) of the appropriate technician. The TII may include a real-time GPS location of their technician as they are dispatched and in-route to the site location. The GPS location can be tracked along a map representation 16 provided through a mapping module via the systemic application (previously loaded on a computing device 10), as illustrated in FIG. 4.

7. The application updates the user with the estimated time of arrival, and call details of the appropriate technician. The estimated time of arrival may be calculated by the mapping module using the TII/GPS location and the inputted user data including site location.

8. The user can also use the application to do other things associated with the service request, like place an order for supplies or set deadlines.

9. As the status of the supply order changes, the application updates the user with updated tracking information and updated estimated time of arrival.

10. The user can also use the application to send the service provider data the provider needs to bill or provide a scope of work and quote/re-quote to the customer. For example, the user can send a periodic meter through the application, that the service provider needs. For instance, if a service provider is managing a device or application for the customer, there can sometimes be a meter associated with the output of that device. For example, a meter of black and white prints, or color prints, done on a copier or printer.

11. The user can use the application to request an account review, or for general customer service from the service provider, whereby the software application represents on the user interface of the computing device 10 a review page 18, as illustrated in FIG. 5.

12. The service provider can use the application to send other news and updates to the user that may impact the scope of work.

13. The user can communicate with the service provider in real-time through the application, including selecting a follow up request and/or a change order regarding the service request data.

In an exemplary embodiment, the components of the application, system and method of the present invention may interrelate as follows, and the application and system may be accessed and used by a user in a method comprising one or more of the following steps and combinations thereof. The user may begin by creating a login account (1) and adding user information and may then proceed to perform any of the other functions the application provides (2-12). For instance, a user may select “place a toner order” during steps 3 and/or 4 via the selection page 14. As the order processes, the user may track information with an estimated time of arrival appearing on the map representation 16 for all open service requests.

In an exemplary embodiment, the application, system, and method of the present invention may function and operate in the following manner. The steps of the application may be implemented or work individually as individual steps in completing a service request. Together, the steps may provide the user the ability to place a request for service from anywhere, at any time, from the user mobile device. The application may also provide real time updates to the user.

In an exemplary embodiment, the application, system, and method of the present invention may be made in the following manner. The person would make the invention by using a programming language to program a mobile application that performs these functions of the application described.

In an exemplary embodiment, the application may comprise as necessary components elements of the application which may allow the user to input data pertaining to their account and service request; elements of the application which may send that data to the service provider; and elements of the application which may provide real-time updates from the application to the user (including the geographic location of the technician). In some embodiments, the elements of the application which enable a user to place a supply order, enter a meter, or request an account review may be optional.

In an exemplary embodiment, the application, system, and method may be used in the following manner, the method may comprise one or more of the following steps. When the user needs service from the service provider, the user may use the mobile application to place a request for service. The service request may then be confirmed and dispatched by the service provider. The application may update the user when the call is dispatched, when the technician is in-route, and may provide the current status with notes from the call. In some embodiments, the application of the present invention may be further automated, and capable of providing automatic updates to the user, as determined by the service provider.

An exemplary embodiment of the present invention may provide a mobile service request application, system and method which enables a user who is a customer of a service provider to place a service call, or a request for service from their mobile phone. The user may then receive live updates about the service request, and view a GPS location of an assigned technician when the technician is on the way to the user location to address to the user request. The user may place a request for service directly from the mobile application, and may also receive live, real-time updates as a call is dispatched and resolved. Based on real-time updates, the system or the user may modify the service request or service provider. Service request data may be logged under the user account, where the user may access and view the user service history.

An exemplary embodiment of the present invention may provide a mobile service application, system and method that is a technician specific, and constructed and arranged to provide to a user who is a service technician to communicate with a service provider organization customer relationship management “CRM” software or electronic records program “ERP”, or any other software program in which customer information may be stored. The system is capable of auto-populating the technician mobile app with relevant customer data and technician data.

An exemplary embodiment of the present invention may provide a mobile service application that is a technician specific mobile application, system and method which enables a user who is a technician to communicate with a service provider organization customer relationship management “CRM” software or electronic records program “ERP”, or any other software program in which customer information may be stored. The system is capable of auto-populating the technician mobile app with customer data, such as, for example without limitation, customer contact information, contractual information, service history, or other relevant customer data. The process may occur any time in the technician application, for example without limitation, when the technician “accepts” the service request in the mobile app, or at any other point in the process. The information may also auto-populate in the customer mobile application. Other examples of data capable of being automatically populated by the system may include technician's drive time, average time on site, completed calls for the day, “first call fix” average or “first call efficiency %”, parts usage per call, and any other key performance indicator data which may be defined by the service organization or technician. All of the data would come from the customer relationship management “CRM” software, electronic records management “ERP” program, third party ERP, any other software program, or any other third-party software program wherein customer information may be stored, whether the customer stores the information themselves or a third party stores the information.

The system may include at least one computer with a user interface. The computer may include at least one processing unit coupled to a form of memory. The computer may include, but may not be limited to, a microprocessor, a server, a desktop, laptop, and smart device, such as, a tablet and smart phone. The computer may include a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The ordered combination of various ad hoc and automated tasks in the presently disclosed platform necessarily achieve technological improvements through the specific processes described more in detail below. In addition, the unconventional and unique aspects of these specific automation processes represent a sharp contrast to merely providing a well-known or routine environment for performing a manual or mental task.

Referring now to the Figures of provisional patent applications, incorporated herein by reference in its entirety, the present invention is directed to a mobile service request application, system and method. In accordance with an embodiment of the present invention, a mobile application may enable a customer of a service provider to use a mobile phone to place a service call, or request for service. The user may then request and receive live updates about the service request and see an assigned technician GPS location when the technician is on the way to the user location to fulfill the user service request.

The app, system and method of the present invention solves problems associated with existing service request systems and methods. In prior methods, when a customer service request has been placed, it has been placed by phone or email with live dispatch personnel. A miscommunication of expectations between the customer and the service company may result from this prior method. Further, following a request for service, a delay may occur.

The present invention avoids associated problems by enabling the user to place a request for service using the mobile application of the present invention from the convenience of a mobile telephone or mobile device, at anytime from anywhere. The user may initiate a request for service directly from the mobile application, and request and receive live real-time updates as the service request and service call is dispatched and resolved. The data of the service request and service call may also be also logged under a user account associated with the user, where the user may access and view the user service history.

The mobile application of the present invention allows the user to place a request for service directly from the user mobile phone or mobile device. Once the request has been successfully sent, real time updates may then be provided to the user directly from the application, including request status, estimated time of arrival, real time geographic location of the assigned technician, name and contact information of the assigned technician, and other data relevant to the user account and service request.

The app, system and method of the present invention differs from and distinguishes over what currently exists. There is currently nothing that exists in its field currently. Similar technology is being used for other industries, like hospitality and transportation for example. The app, system and method of the present invention provides an unprecedented improvement over existing service call fulfillment which remedies problems caused by service provider communication and response limited to live phone calls, email, or chat and the consequent delay in updates to the customer, and problems in communication.

In accordance with the app, system and method of the present invention, a user may place a request for service directly from the mobile application, where they will also receive live real-time updates as the call is dispatched and resolved. This data may also be logged under the user account, where the user may access and view the user service history.

In an exemplary embodiment the app and system of the present invention may be accessed and used in a method comprising one or more of the following steps and combinations thereof.

1. If a dispatched technician is detected to be not moving or moving very slowly for a predetermined period, for example because he/she is stuck in traffic, the system is capable of and may dispatch another technician.

2. The system is capable of enabling a service requester to observe the planned route of the technician and direct that the technician travel via a different route.

3. Under a service level agreement between the service provider and the service requester, if the system determines, or if the service requester via his/her mobile device determines, that the technician cannot reach the site of the problem by an agreed time for any reason, another technician may be dispatched or the service requester may be given a refund or credit of some type or discount on supplies.

4. The service requester may be provided an opportunity to choose from several nearby service provider technicians based on service requester's knowledge of the various technicians' present locations and knowledge of current traffic conditions.

5. Service providers and their technicians may be provided the opportunity to enter bids to provide service to the service requester.

6. Technicians may display their skill set specialties in response to a service requester having opened a request. The service requester may view the skill specialties and select the technician he/she wants, and the chosen technician may be dispatched.

An exemplary embodiment of the present invention may provide a mobile service application, system and method that is a technician specific, and constructed and arranged to provide to a user who is a technician and may enable the technician to communicate with a service provider organization customer relationship management “CRM” software or electronic records program “ERP”, or any other software program in which customer information may be stored. All of the data may come from the customer relationship management “CRM” software, electronic records management “ERP” program, third party ERP, any other software program, or any other third party software program wherein customer information may be stored, whether the customer stores the information themselves or a third party stores the information. The system is capable of auto-populating the technician mobile app with customer data, such as, for example without limitation, customer contact information, contractual information, service history, or other relevant customer data. The process may occur any time in the technician mobile application, for example without limitation, when the technician “accepts” the service request in the mobile app, or at any other point in the service technician process, the service customer process, or the overall system process. The information may also auto-populate in the customer mobile application or technician mobile application. Other examples of data capable of being automatically populated by the system may include technician's drive time, average time on site, completed calls for the day, “first call fix” average or “first call efficiency %”, parts usage per call, and any other key performance indicator data which may be defined by the service organization or technician. All of the data would come from the customer relationship management “CRM” software, electronic records management “ERP” program, third party ERP, any other software program, or any other third-party software program wherein customer information may be stored, whether the customer stores the information themselves or a third party stores the information.

In a technician specific mobile application that is part of this process, the app may communicate with the service organization's customer database, where customer information is stored. This may be a relationship management software “CRM”, or “ERP” (electronic records program), or any other software program where customer information is stored. =It may then auto-populate into the mobile app the customer's data, including but not limited to their service history, contact information, contractual information, and any other customer data. The process may happen anytime in the technician application, for example when the technician “accepts” the service request in the mobile app, or at any other point in the process. The information may auto-populate in both the technician mobile application and the customer mobile application.

Other nonlimiting examples of data that may populate automatically may include the technician's drive time, average time on site, completed calls for the day, “first call fix” average or “first call efficiency %”, parts usage per call, and other key performance indicator data. All of this data may come from the service organization's database, whether that database is self-managed by the service organization or provided by a third-party. The mobile application may also populate data from a third-party database, third-party customer relationship management software “CRM” or 3rd party “ERP” (electronic records program), or any other third-party software program where customer information is stored, whether they store it themselves, or work with a 3rd party to do so.

In summary, an exemplary embodiment of the present invention may provide a mobile service request application, system and method which enables a user who is a customer of a service provider to place a service call, or a request for service from their mobile phone. The user may then receive live updates about the service request and view a GPS location of an assigned technician when the technician is on the way to the user location to address to the user request. The user may place a request for service directly from the mobile application, and may also receive live, real-time updates as a call is dispatched and resolved. Based on real-time updates, the system or the user may modify the service request or service provider. Service request data may be logged under the user account, where the user may access and view the user service history.

An exemplary embodiment of the present invention may provide a mobile service application, system and method that is a technician specific, and constructed and arranged to provide to a user who is a service technician to communicate with a service provider organization or third-party customer relationship management “CRM” software or electronic records program “ERP”, or any other software program in which customer information may be stored. The system is capable of automatically populating the technician mobile app with relevant customer data and technician data.

In summary, an exemplary embodiment of the present invention may provide a mobile service request application, system and method which enables a user who is a customer of a service provider to place a service call, or a request for service from their mobile phone. The user may then receive live updates about the service request and view a GPS location of an assigned technician when the technician is on the way to the user location to address to the user request. The user may place a request for service directly from the mobile application, and may also receive live, real-time updates as a call is dispatched and resolved. Based on real-time updates, the system or the user may modify the service request or service provider. Service request data may be logged under the user account, where the user may access and view the user service history.

The computer-based data processing system and method described above is for purposes of example only and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

References to a network may include any interconnecting system capable of transmitting audio, video, signals, data, messages, or any combination of the preceding. The network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

The server and the computer of the present invention may each include computing systems. This disclosure contemplates any suitable number of computing systems. This disclosure contemplates the computing system taking any suitable physical form. As example and not by way of limitation, the computing system may be a virtual machine (VM), an embedded computing system, a system-on-chip (SOC), a single-board computing system (SBC) (e.g., a computer-on-module (COM) or system-on-module (SOM)), a desktop computing system, a laptop or notebook computing system, a smart phone, an interactive kiosk, a mainframe, a mesh of computing systems, a server, an application server, or a combination of two or more of these. Where appropriate, the computing systems may include one or more computing systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example and not by way of limitation, one or more computing systems may perform in real time or in batch mode one or more steps of one or more methods described or illustrated herein. One or more computing systems may perform at different times or at different locations one or more steps of one or more methods described or illustrated herein, where appropriate.

In some embodiments, the computing systems may execute any suitable operating system such as IBM's zSeries/Operating System (z/OS), MS-DOS, PC-DOS, MAC-OS, WINDOWS, UNIX, OpenVMS, an operating system based on

LINUX, or any other appropriate operating system, including future operating systems. In some embodiments, the computing systems may be a web server running web server applications such as Apache, Microsoft's Internet Information Server™, and the like.

In particular embodiments the computing systems includes a processor, a memory, a user interface and a communication interface. In particular embodiments, the processor includes hardware for executing instructions, such as those making up a computer program. The memory includes main memory for storing instructions such as computer program (s) for the processor to execute, or data for processor to operate on. The memory may include mass storage for data and instructions such as the computer program. As an example and not by way of limitation, the memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments the memory is non-volatile, solid-state memory.

The user interface includes hardware, software, or both providing one or more interfaces for communication between a person and the computer systems. As an example, and not by way of limitation, a user interface device may include a keyboard, keypad, microphone, monitor, mouse, printer, scanner, speaker, still camera, stylus, tablet, touchscreen, trackball, video camera, another suitable user interface or a combination of two or more of these. A user interface may include one or more sensors. This disclosure contemplates any suitable user interface and any suitable user interfaces for them.

The communication interface includes hardware, software, or both providing one or more interfaces for communication (e.g., packet-based communication) between the computing systems over the network. As an example and not by way of limitation, the communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example and not by way of limitation, the computing systems may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing systems may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing systems may include any suitable communication interface for any of these networks, where appropriate.

It should be understood, of course, that the foregoing relates to exemplary embodiments of the invention and that modifications may be made without departing from the spirit and scope of the present invention.

It should be understood, of course, that the foregoing relates to exemplary embodiments of the invention and that modifications may be made without departing from the spirit and scope of the invention as set forth in the following claims.

What is claimed is:

1. A service provider system, comprising:
a plurality of service provider computing devices connected as a network of computing devices, wherein each respective service provider computing device is configured to transmit a GPS signal and a service provider identifier thereof; each service provider computing device has a provider communication interface;
a user computing device having a user communication interface in receipt of a site location and a service request comprising service request data; and
a server coupling the plurality of service provider computing devices and the user computing device so that one of the plurality of service provider computing devices is assigned to the service request based in part on the site location and the service request data, wherein the GPS signal of the assigned service provider computing device is represented on a map on the user communication interface.

2. The service provider system of claim 1, wherein the server is configured to represent on the user communication interface an estimated time of arrival of the GPS signal at the site location.

3. The service provider system of claim 2, wherein the server is configured to represent on the user communication interface the service provider identifier.

4. The service provider system of claim 3, wherein the service provider identifier includes a name and a contact information.

5. The service provider system of claim 4, wherein the service provider identifier includes a name and a contact information.

6. The service provider system of claim 5, wherein the service request data comprises a description of a service.

7. The service provider system of claim 6, wherein the service request data comprises a deadline, and wherein the server is configured to reassign another of the plurality of service provider computing devices based on the description of a service, the deadline, and the GPS signal of the assigned service provider computing device.
